(19) United States
(12) Patent Application Publication
(10) Pub. No.: US 2007/0204493 A1
(43) Pub. Date: Sep. 6, 2007

(54) LABELS FOR ELECTRONIC DEVICES

(75) Inventors: James A. Foley, Wellesley, MA (US); Gary L. Wamer, Warwick, RI (US)

Correspondence Address: BARLOW, JOSEPHS & HOLMES, LTD., 101 DYER STREET, 5TH FLOOR, PROVIDENCE, RI, 02903, US

(73) Assignee: ARKWRIGHT, INC., Fiskeville, RI (US)

(21) Appl. No.: 11/738,848

(22) Filed: Apr. 23, 2007

Related U.S. Application Data
(63) Continuation-in-part of application No. 11/326,644, filed on Jan. 6, 2006.
(60) Provisional application No. 60/641,698, filed on Jan. 6, 2005.

(51) Int. Cl. G09F 3/10; B41M 5/00; C08F 2/46; G08B 1/08; G08B 13/14

(52) U.S. Cl. 40/299.01; 340/572.8; 340/539.13; 427/487; 428/195.1

(57) ABSTRACT

An electronic device decorative surface label comprising: a) a substrate having a first surface and a second surface, b) an adhesive layer on said first surface for affixing said label to the outside surface of an electronic device and the second surface is coated with an inkjet printable medium having a supporting intermediate coating overlying the imaging surface of the substrate and a microporous ink-receptive coating overlying the supporting intermediate coating. The label may add other feature, such as RFID, GPS and color change during use.

### CROSS-REFERENCE TO RELATED APPLICATIONS

The present application is a continuation-in-part of U.S. application Ser. No. 11/326,644, filed on Jan. 6, 2006 and claiming priority on Provisional Application No. 60/641,698, filed Jan. 6, 2005. Each of the aforementioned related patent applications is herein incorporated by reference.

### BACKGROUND OF THE INVENTION

The use of electronic devices has opened a new market for communications and entertainment. The proliferation of computers, PDAs, cell phones and other electronic devices has resulted in potential theft issues, misidentification among owners and opens the gateway to addition of personal identification features to the exterior of the electronic device. For example, the website www.skinit.com sells “skins” for application to the external surface for cell phones, laptop computers and other electronic devices. The use of skins provides a means for identifying an individuals electronic device form similar devices and can be used to add a decorative feature. For example, a laptop skin can be the size of the top of the laptop and can display a pet or loved one. Although these uses are beneficial, the design of the label for the electronic device has been a continuing effort by many inventors.

Representative label designs are disclosed in the following patents and pending patent applications, incorporated herein in their entirely by reference thereto: U.S. Published Patent Application No. 2006/0040081 entitled “Apparatus, System, and Method for Personalizing a Portable Electronic Device; U.S. Published Patent Application No. 2005/0271864 entitled “Method Of Providing Decoration Labels For Customization Of Portable Electronic Devices”; U.S. Published Patent Application No. 2006/0233994 entitled “Mobile Device Label with Negative Image Feature”; U.S. Published Patent Application No. 2005/0116334 entitled “Protective Cover for Electronic Device”; WO99/52719/EP0988998 entitled “System For Making Ornamental Seal FOR Small Electronic Device”; U.S. Published Patent Application No. 2006/00223872 entitled “Portable Electronic Device Customization Kit”; U.S. Published Patent Application No. 2006/0037507 entitled “Printable Cover System for Articles”; JP 11-031561/PN2000-231333 entitled “Production of Seal for Decoration”; and U.S. Pat. No. 6,660,389 entitled “Information Display Protectors”.

In view of the foregoing, the label designs deal with the design of the label and the use of a label on various electronic devices. Unfortunately, the aforementioned label designs fail to deal with the composition of the label. The instant invention claims a label construction found to be outstanding for use of a label with electronic devices.

### BRIEF SUMMARY OF THE INVENTION

The invention relates to a printable medium on a substrate that may be used for a label for an electronic device. The label substrate will have an adhesive for affixing the label to an external surface of the electronic device.

The electronic device can be any one the known electronic devices and can include electronic devices selected from the group consisting of cellular phones, computers, laptop computer, personal display assistants, (PDAs) palm pilots, computers, laptop computers, MP3 players, iPods, music devices, video devices, portable music devices, portable video devices, portable audio devices, electronic organizers, remote controls for electronic devices, display terminals and electronic gaming systems (including XBOX®, PS3®.NINTENDO®, and GAMBOY® systems).

Unlike the above-mentioned prior art, the instant labels can provide features in addition to the images added to the label. The instant invention provides a novel microporous medium for use in a label for electronic devices, such as cell phone, laptop computers and MP3 players, such as the well-known iPod music players. One of the functional aspects of the electronic devices is the generation of heat during their operation and use. For example, the screens of all laptop computers are formed from LCD or plasma screens that are charged with electricity to form the screen image. The laptop computer generates heat during operation and this heat from the processor and components and/or screen is best removed and may be used for or support other functions to be provided from the label, in addition to the label's graphic functions. For example, the label placed on a laptop can include a heat active color change dye or odor/fragrance release resin or a sound generating resin whereby after the laptop is turned on it will change colors and/or generate an odor/fragrance and/or generate a sound. Since the color change or odor release or sound component can be added to the interlayer or ink-receptive layer, it will become a functional feature of the label during use of the label. The use of color change, odor/frangrance or sound will further serve to personalize the laptop computer to which the label has been affixed. In another embodiment the color change, odor/fragrance generating or sound generating feature is added to the printed label during the image-printing step as a functional component of the ink being applied to the label or though a reaction between the ink and the label. The use of color change media useable herein is disclosed in U.S. Pat. No. 6,188,506, incorporated herein by reference thereto. The label can also be imaged with color change ink, such as disclosed in U.S. Pat. No. 6,188,506, incorporated herein by reference thereto. The use of odor/fragrance release resin or other media to provide odor/fragrance release to the labels are disclosed in U.S. Pat. Nos. 6,648,980, 6,648,950 and 5,093,182, incorporated herein by reference thereto.

The generation of a sound by the label can be through a heat activated additive that pops upon heating or may to an electronic chip assembly of the type commonly found in greeting cards. In one embodiment the label contains a sound generating electronic chip assembly that plays a song, such as “Happy Birthday” when the label is touched. In one embodiment the sound generating electronic chip is interactive with a WiFi network and can be activated to play the song via the Internet. The label may be placed on a laptop computer wherein: a) said label has a printed image and contains a sound generating electronic circuit and a WiFi electronic circuit; b) and said sound generating electronic circuit can be activated to make a sound through said WiFi electronic circuit thru a signal sent through the Internet and received by a circuit, such as disclosed in U.S. Pat. No. 6,917,336, incorporated herein by reference thereto. In one embodiment the image printed on the label is related to the sound that the electronic circuit will play when activated. For example, if the label is provided for a birthday, the image can be a cake with candles and the sound will be the melody “Happy Birthday to you.”. Since the sound activation is remote, the song will also function as a birthday surprise gift.

In another embodiment, the safety recognition benefits of a personalized imaged label can be enhanced though the use of an RFID (Radio Frequency Identification) chip assembly in the substrate layer. The use of ink-jet printable RFID circuits of sufficient design for use as the substrate layer is disclosed in U.S. Pat. No. 7,158,033 and may be included as the substrate layer in the label for a electronic device. In one embodiment the RFID is also a GPS (Global Positioning System) chip for satellite location by GPS tracking devices of the type used in cell phones, such as Nextel and Sprint. These chips and the tracking services are well known in the prior art. After the image containing label with a RFID or GPS substrate is added to a laptop the laptop will have the security of visual identification and be traceable with an RFID or GPS tracking device. In one embodiment the substrate upon which the printable medium coating may be placed is an RFID label. For example the substrate may be a RFID and GPS label of the type disclosed in U.S. Pat. No. 6,614,392, incorporated herein by reference thereto. The use of RFID transmitters and tracking devices in labels and tags is well known in the art as shown in U.S. Pat. Nos. 7,158,033 and 7,170,415, 7,158,033, 6,107,920, 6,206,292 and 6,262,292, incorporated herein by reference thereto.

In one embodiment the printed label is further covered with a laminate, such as an ACCO brand laminates sold by ACCO Brands Corporation.

It is therefore an object of the embodiment to provide a label that has a microporous medium for use in a label for electronic devices, such as cell phone, laptop computers, MP3 players, and iPod music players.

It is a further object of the embodiment to provide label that when placed on an electronic device can include a heat active color change dye or odor/fragrance release resin or a sound generating resin whereby after the electronic device is turned on the label will change colors and/or generate an odor/fragrance and/or generate a sound.

Another object of the embodiment to provide a label with a RFID or GPS substrate to be traceable with an RFID or GPS tracking device.

### BRIEF DESCRIPTION OF THE DRAWINGS

The novel features which are characteristic of the labels for electronic devices are set forth in the appended claims. However, the labels for electronic devices, together with further embodiments and attendant advantages, will be best understood by reference to the following detailed description taken in connection with the accompanying drawings in which:

FIG. 1 is a cross sectional view of a label and the layers forming the label; and

FIG. 2 is a top view of a representative label with a die-cut pattern for use on a laptop computer.

### DETAILED DESCRIPTION OF THE PREFERRED EMBODIMENTS

The present invention uses the microporous printable medium of U.S. Ser. No. 11/326,664, filed Jan. 6, 2006, incorporated herein by reference, to produce labels for electronic devices. The use of the microporous medium of U.S. Ser. No. 11/326,664 provides a high quality inkjet printable medium with a high gloss, smear resistant surface.

In addition, the microporous printable medium having high gloss and smear resistant inkjet printable surface is combined with other new features for labels for electronic devices, such as RFID, color change and odor/fragrance generation. In another embodiment the label is a color change label, which can change color and obscure the printed image. In another embodiment the label is a color change label without an image for changing the color of a laptop computer during use, acting as an “I am working” indicator. The use of the microporous medium to form the label for the electronic device solves the prior art use of expensive materials like employed for the labels sold at www.skinit.com. This also solves the problems of the prior art by providing an ink-jet printable medium that includes a substrate having an imaging surface with a stable absorptive and supporting intermediate coating (intercoat) overlying the imaging surface and a microporous ink-receptive coating overlying the intercoat with improved resistance to smearing during frequent human contact.

The printable medium on the substrate is formed of an intermediate coating (Intercoat) and an ink receptive absorptive layer (Topcoat). Depending on the choice of substrate it may be advantageous to provide the substrate with a primer prior to coating with the intercoat and topcoat.

The intermediate coating (intercoat) can comprise one or more constituents that can provide beneficial mechanical properties and one or more ink-vehicle absorptive materials. In one preferred embodiment, the materials providing the beneficial mechanical properties are polymers. In another, one or more particulates and one or more polymers are used. In a more preferred embodiment, the polymers are two acrylic polymers; one with a glass transition, Tg, below the normal use temperature range, and the other with a Tg above this range. In a most preferred embodiment, the higher Tg is also above the process drying temperature. In these embodiments, the ink-vehicle absorptive material is a water absorptive polymer, such as poly(vinylpyrrolidone) (PVP), PEOX, polyvinyl alcohol (PVA), or an alkylcellulose, such as methyl cellulose (methocel).

Other preferred embodiments can be formulated in accordance with the teachings of the invention. Thus, in another preferred embodiment, the intercoat can comprise constituents that can combine beneficially with the microporous topcoat selected for the medium. When the topcoat comprises polymers, such as PVA, that can interact beneficially with borates, the intercoat preferably can comprise borates.

Other embodiments of the invention consist of analogous constituents selected for media in which the ink-vehicle is a liquid other than water. For example, the ink vehicle may be any vehicle that is liquid during the application of the ink to create the image. When the ink-vehicle or the coating vehicle is not water, the absorbants are selected for these vehicles.

The resulting ink-jet imaging medium produced in accordance with this invention has many desirable properties. The ink-jet imaging medium of this invention offers several improvements over conventional ink-jet media. First, the porous ink-receptive layer can have a lower coat weight, because the intercoat layer has ink-vehicle absorbing properties. Secondly, the topcoat may have a higher pigment to binder mass ratio because less film-forming binder is needed in the top coat to form a stable topcoat film when it is coated and dried over the intercoat of this invention. Thirdly, although there is an increase in the pigment to binder mass ratio of the top coat, the ink-jet media of this invention can be manufactured at a faster coating line speed and higher temperature drying conditions than an analogous medium without this intercoat. Thus, the manufacturing process used to make the ink-jet media of this invention is both robust and cost-effective.

Other advantages of the intercoat layer include the controlled swelling and wet strength of this layer. The wet strength of the intercoat layer means that the highly pigmented microporous layer can be coated effectively over this intercoat layer. This combination of coatings provides a final coated medium having a strong and durable coating that is less likely to crack under stresses.

Also, the media of this invention have improved ink-drying times over conventional media. The ink-jet imaging medium has good water-resistance so that the printed image is less likely to smear or rub-off after the image is wetted. The ink-jet medium can produce high quality printed images having high color brilliance, sharpness, and fidelity.

Substrate

The substrate material may be a paper material or coated paper material, but is preferably a vinyl or plastic material. In one embodiment the substrate is a calendared vinyl material. The substrate may be a polymeric film comprising a polymer such as, for example, polyethylene, polypropylene, polyester, naphthalate, polycarbonates, polysulfone, polyether sulfone, poly(arylene sulfone), cellulose triacetate, cellophane, polyvinyl chloride, polyvinyl fluoride, polyimides, polystyrene, polyacrylics, polyacetals, ionomers, and mixtures thereof. Since the label also protects the electronic device's external surface, a tear resistant and water resistant material, such as vinyl, is preferred. In other instances, a metal foil such as aluminum foil or a metal-coated material can be used as the substrate. In other embodiments the substrate can provide additional features, including color change, odor/fragrance generation, sound and security tracking by use of RFID and/or GPS.

The substrate material has two surfaces. The first surface, which is coated with the ink-receptive printed medium layers in accordance with this invention, may be referred to as the “front” or “imaging” surface. The second surface, which is opposite to the first surface, may be referred to as the “back” or “non-imaging” surface and is coated with the adhesive, preferable a pressure contact adhesive and liner.

It is desired that any conventional PSAs may be employed, including silicone-based PSAs, rubber-based PSAs, and acrylic-based PSAs. Representative pressure sensitive adhesives are well known in the art. Such pressure sensitive and removable adhesives are generally available from Avery, FLEXcon and 3M. One suitable repositionable adhesive is a microsphere adhesive. An exemplary microsphere adhesive includes polyacrylic derivatives. The repositionable adhesive can be solvent based, water based, or can be a solventless, hot melt adhesive. Suitable repositionable adhesives include those disclosed in the following US patents: U.S. Pat. No. 3,691,140 (Silver); U.S. Pat. No. 3,857,731 (Merrill et al.); U.S. Pat. No. 4,166,152 (Baker et al.); U.S. Pat. No. 4,495,318 (Howard); U.S. Pat. No. 5,045,569 (Delagado); U.S. Pat. No. 5,073,457 (Blackwell) and U.S. Pat. No. 5,571,617 (Cooprider et al.), U.S. Pat. No. 5,663,241 (Takamatsu et al.); U.S. Pat. No. 5,714,327 (Cooprider et al.); U.S. Pat. No. RE 37,563 (Cooprider et al.); and U.S. Pat. No. 5,756,625 (Crandall et al.); U.S. Pat. No. 5,824,748 (Kesti et al.); and U.S. Pat. No. 5,877,252 (Tsujimoto et al.). The substrate may be provided with the PSA as a single coating or is provided as a pattern on the first surface, such as stripes or dots wherein only a portion of the first surface of the substrate is covers by the PSA. The release liner for the PSA can be any of those employed in the prior art, include the release liners disclosed in U.S. Pat. Nos. 6,403,190 and 6,110,552, incorporated herein by reference hereto. In one embodiment the release liner, PSA and vinyl film are sold as a single substrate component and are sold under the trade designation Flexmark® V 400 white opaque A-58 90 PFW by FLEXcon. This is a flexible white opaqe vinyl film coated with a removable pressure sensitive acrylic adhesive and backed with a two-sided poly coated lay flat release liner. The thickness of the film is 3.5 mil, adhesive is 0.8 to 0.9 mil and the liner is 6.9 mil. The adhesion properties of the removable adhesive are 9 oz/in for polypropylene and 27 oz/in for acrylic as measured by ASTM D 903 (modified for 72 hr dwell time) with a tack (gm) of 230 (ASTM D 2979). The primer layer, intercoat layer and topcoat layer are placed on the FLEXmark® V 400.

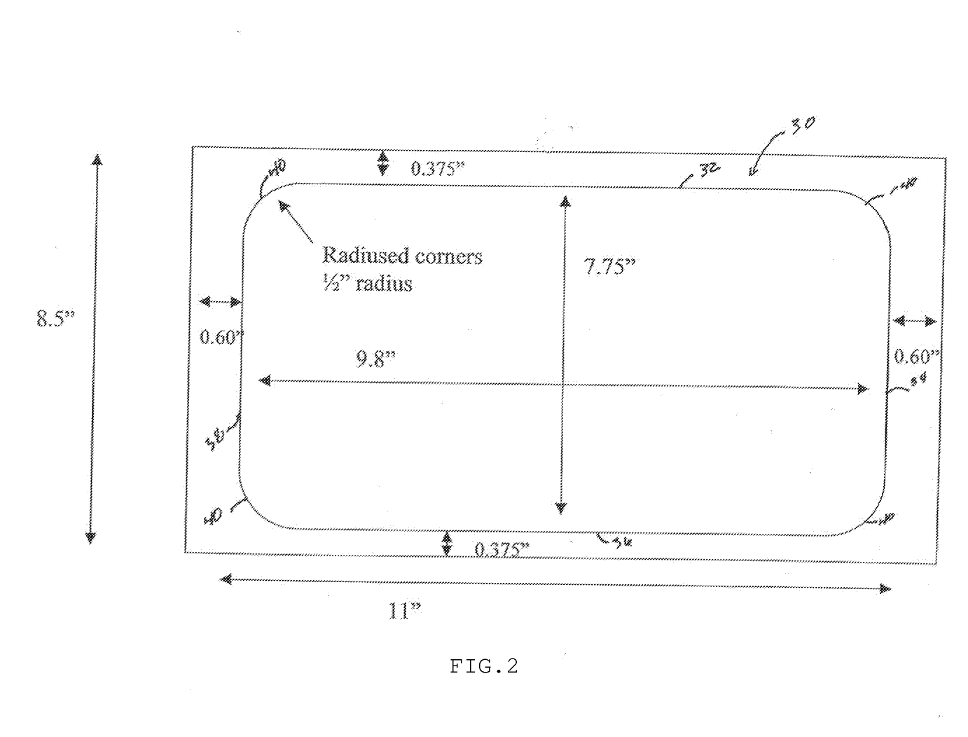

The substrate can be precut to a label shape suitable for attachment to the electronic device. The label can be cut by any of the know methods, such as die cutting, whereby areas are formed that can be removed from the liner by peeling away a section with the PSA attached thereto. In one embodiment the design of the electronic device is printed on the label as the outermost design and the design is cut out with a cutter like scissors. It is preferred to precut the shape into the film and not the liner so the shape can be easily peeled away from the liner. When the label is precut in a rectangular shape for use on a laptop computer top and or bottom, the design is widely usable owning the limited number of laptop computer screen sizes, such at 15,4″, 15″, 14.1″ and 12.1″ screens. FIG. 2 shows a die cut rectangular label, but the die cut design can be any geometric design, including rectangular, square, circular, trapezoidal, elliptical and any hand drawn form. In one embodiment the label is printed with an inkjet or laser image to contain text, graphics, photographs, advertisements, bar codes or a combination thereof for personal identification, decorative enhancement and tracking of the electronic device associated with the label.

The thickness of the label is governed mostly by the thickness of the liner, PSA and substrate containing the printing medium. The label will typically have a thickness in the range of 3 mil to 20 mil and more preferably between about 3 mil and about 15 mil.

The intercoat and microporous layers are generally coated onto the substrate film and then dried. Since the drying process employs a heating step the components in the label will need to be correlated to the drying procedure to prevent the loss of any added functionality, such as color change, odor/fragrance generation, RFID and/or GPS functionality and the like.

Supporting Underlayer (Intermediate coating) (Intercoat)

In the present invention, the imaging surface of the substrate 12 is coated first with at least one supporting underlayer or intermediate coating 14 (intercoat). One function of the intercoat 14 is to provide a strong, stable and ink-vehicle absorptive support layer for the ink-receptive microporous topcoat 16, which is applied over the intercoat 14. In one embodiment a primer is firs coated on the substrate.

The intercoat 14 may be applied to the substrate as a wet coating and subsequently dried in a first drying cycle. Then, the top coat 16 is applied, preferably as a wet coating, over the intercoat 14 and the fully coated medium is dried in a second drying cycle. The intercoat 14 and top coat 16 formulations may be applied to the substrate using conventional coating methods such as, for example, Meyer-rod, roller, blade, wire bar, dip, solution extrusion, air-knife, curtain, slide, doctor-knife, and gravure methods. Alternatively, application of the intercoat may be done by lamination or other suitable means known in the art. The coating formulations are dried using conventional techniques such as forced hot air ovens or dryers.

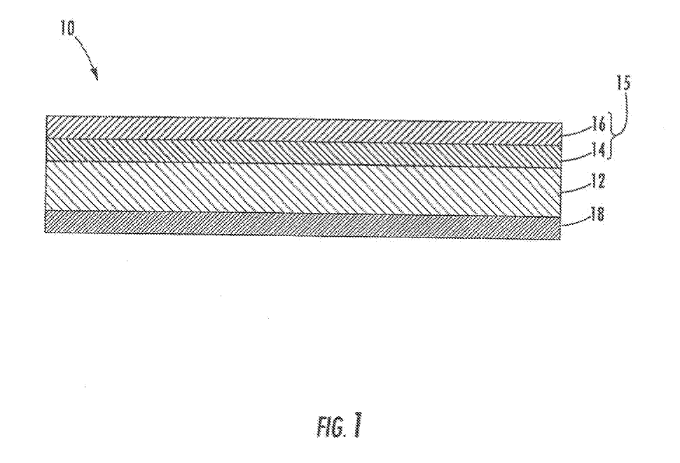

FIG. 1 shows a representative label with substrate 12 (formed of a release liner, PSA and vinyl film), primer 13, intercoat 14 and topcoat 16. Unlike vinyl-imprinted labels, the instant invention provides a photo quality surface for printing photographic quality images and text. In addition, the images can be formed with dye-based and pigment-based inkjet inks. Although not wishing to be bound by any particular mechanistic interpretation, it is believed to be important that the intercoat 14 has good mechanical integrity and the capability to absorb moisture from the topcoat 16 during the second drying cycle. The coated web 15 is susceptible to splitting during the initial phase of the second drying cycle when forcing conditions are used. It is believed that the intercoat 14 of this invention prevents splits from generating in the coated web by increasing the wet strength of the web coating 15. This stability enhances the use of the microporous coating as a print surface during the extended use and contact that a printed image will endure when inkjet or otherwise printed on the topcoat. In this interpretation, the intercoat 14 absorbs some water (i.e., “dewaters”) the topcoat 16 as the coated web 15 enters the dryer. Particularly, the intercoat 14 absorbs moisture from the topcoat 16 while moisture is being removed by drying from the top surface of the coated web 15. This controlled dewatering step improves the wet strength of the topcoat 16 so that the coated web 15 can withstand the stresses imparted thereon during this drying step. This results in minimal or no splits forming in the topcoat 16.

Furthermore, it is important that the intercoat 14 be stable at the higher temperatures of the coated web 15 during the later phase of the second drying cycle. Cracks may propagate in the coated web 15 during this phase of the drying cycle. It is believed that the intercoat 14 prevents cracks from forming in the coated web 15 at this point, because the intercoat 14 has high stability and also may mechanically bond to the top coat 16, thereby forming a reinforced coated web 15 having high mechanical integrity.

The intercoat 14 of this invention may be prepared from a coating formulation comprising a blend of at least one acrylic copolymer and poly(vinyl pyrrolidone) (PVP), poly(2-ethyl-2-oxazoline) (PEOX), a poly(vinyl alcohol)(PVA), and/or an alkylcellulose, such as methocel. The acrylic copolymer, PVP, PVA, methocel and PEOX are film-forming materials. The acrylic copolymer may be selected from such polymers as, for example, styrene acrylics (available under the tradenames of Joncryl 624 and Joncryl HPD-71 from Johnson Polymers). In one embodiment, a blend comprising an acrylic copolymer having a relatively low Tg and PVP is used. Particularly, a blend comprising an acrylic copolymer having a Tg of less than 25° C., and PVP can be used. For example, the acrylic copolymer, Joncryl 624 has a relatively low glass transition temperature (Tg) of about −30° C. The acrylic copolymer is typically present in the intercoat in an amount of about 60% to about 90%, and the PVP is present in an amount of about 10% to about 40% based on dry weight of the intercoat. It has been found that the combination of the Joncryl 624 material and the PVP provides a stable and absorptive intercoat that effectively supports the top coat. This results in a coated media product 10 that does not develop splits during the drying process.

In another embodiment of the intercoat 14, a blend comprising an acrylic copolymer having a relatively low Tg; an acrylic copolymer having a relatively high Tg; and PVP is used. For example, an acrylic copolymer having a Tg of less than 25° C. may be used in combination with an acrylic copolymer having a Tg of greater than 25° C. The acrylic copolymer having the relatively low Tg typically is present in the intercoat in an amount of about 20% to about 60%, the acrylic copolymer having the relatively high Tg typically is present in the intercoat in the amount of about 10% to about 40%, and the PVP typically is present in the intercoat in the amount of about 20% to about 40% based on dry weight of the intercoat layer 14. The acrylic copolymer, Joncryl HPD-71 has a Tg of about 128° C. It has been found that the combination of the Joncryl 624 and Joncryl HPD-71 materials and the PVP provides a stable intercoat 14 having good mechanical properties at high drying temperatures. The intercoat 14 has good thermal stability. This results in a coated media product 10 that does not develop unacceptable levels of cracking during the drying process.

In addition, it has been found that an acrylic copolymer or blend of acrylic copolymers having a relatively high acid functionality, e.g. acid number, also provides the coating with additional beneficial properties. For example, it may be desirable to use an acrylic copolymer having an acid functionality of at least 25. The Joncryl 624 material has an acid number of 50, and the Joncryl HPD-71 material has an acid number of 214. It is believed that acrylic copolymers having a high acid functionality provide the coating with useful ink-vehicle absorptivity. The moisture sensitivity of the coating may be controlled and enhanced by using these high acid acrylic copolymers in combination with the absorptive material in the intercoat, such as PVP.

Alternatively, the intercoat 14 may be prepared from a coating formulation comprising a blend of at least two polymeric materials and an absorbing polymer where at least one of the polymeric materials has a Tg less than 25 degrees Celcius and at least one polymeric materials has a Tg greater than 25 degrees Celcius and the absorptive material is selected from a group consisting of poly(vinyl pyrrolidone) (PVP), poly(2-ethyl-2-oxazoline) (PEOX), a poly(vinyl alcohol)(PVA), and/or an alkylcellulose, such as methocel.

The intercoat 14 also may contain functional additives such as inhibitors, surfactants, waxes, plasticizers, cross-linking agents, dye fixatives, de-foaming agents, pigments, dispersing agents, optical brighteners, UV light stabilizers (blockers), UV absorbers, adhesion promoters, and the like. In particular, it has been found that borate salts (sodium tetraborate decahydrate and/or potassium tetraborate decahydrate) (generally known as Borax), may be may be added as a cross-linking agent to the coating formulation for the intercoat. It is believed that borate salts, such as the Borax material, will gel with certain of the binders that are used in the topcoat, such as poly(vinyl alcohol) or polysaccharide material in the top coat. If borate salts are added to the intercoat 14, they should be added in a relatively small amount (typically 0.05 gsm to 1 gsm). This amount may be adjusted to account for changes in the topcoat binder.

It also is recognized that the intercoat 14 of this invention may have good ink-receiving properties. In other words, the intercoat 14 may be capable of absorbing pigmented and dye-based inks from ink jet printers to form a printed image.

Microporous Ink-Receptive Layer (Topcoat)

A microporous ink-receptive layer 16 is applied over the supporting intercoat layer 14. The porous ink-receptive layer 16 contains particles and a polymer binder. These particle and polymer binder materials provide the ink-receptive layer 16 with a porous morphology. This porous structure enables the ink-receptive layer 16 to better absorb the aqueous ink vehicle (water). The particles form interstitial pores or voids in the ink-receptive layer 16 so that the layer can absorb the liquid by a wicking or capillary action as well as by polymers and other absorptive components. As ink is impinged onto the layer 16, it enters these interstitial voids and is absorbed effectively. The blend of particles and polymer binders in the ink-receptive layer 16 contributes to the relatively fast ink-drying times of the media.

Suitable inorganic particles that can be used in the ink-receptive layer 16 include, for example, those selected from the group consisting of kaolin, talc, clay, calcium sulfate, calcium carbonate, alumina, aluminum silicate, colloidal alumina, silica, silica-alumina, alumina coated silica, colloidal silica, lithopone, zeolite, hydrated halloysite, magnesium hydroxide, magnesium carbonate, barium sulfate, titanium dioxide, zinc oxide, zinc sulfate, and zinc carbonate particles. Suitable organic polymer particles include, for example, those selected from the group consisting of polyethylene, polypropylene, polyacrylate, polymethacrylate, polystyrene, fluoropolymer, and polyester particles. The particles, themselves, can have a high surface area and porous structure. Such porous particles can absorb the aqueous ink vehicle themselves in addition to forming voids in the ink-receptive layer.

In the present invention, the ink-receptive layer 16 may contain 40% to 96% particles by weight based on dry weight of the ink-receptive layer 16. Preferably, it contains 80%-96% by weight.

The binder resin used in the porous ink-receptive layer 16 provides cohesion and mechanical integrity to the porous ink-receptive layer 16. The binders typically are water-soluble or water-dispersible, especially when the ultimate application is aqueous-based ink jet printing, and include, for example, those selected from the group consisting of polyvinyl alcohols (PVAs); modified polyvinyl alcohols (e.g., carboxyl-modified PVA, silicone-modified PVA, maleic acid-modified PVA, and itaconic acid-modified PVA); polysaccharides; polyurethane dispersions; acrylic copolymers; vinyl acetate copolymers; poly(vinyl pyrrolidone); vinyl pyrrolidone copolymers; poly(2-ethyl-2-oxazoline); poly(ethylene oxide); poly(ethylene glycol); poly(acrylic acids); starch; modified starch (e.g., oxidized starch, cationic starch, hydroxypropyl starch, and hydroxyethyl starch), cellulosic polymers oxidized cellulose, cellulose ethers, cellulose esters, methyl cellulose, hydroxyethyl cellulose, carboxymethyl-cellulose, benzyl cellulose, phenyl cellulose, hydroxypropyl cellulose, ethyl hydroxyethyl cellulose, hydroxyethyl methyl cellulose, hydroxypropyl methyl cellulose, hydroxy butylmethyl cellulose, dihydroxypropyl cellulose, hydroxypropyl hydroxyethyl cellulose, chlorodeoxycellulose, aminodeoxycellulose, diethylammonium chloride hydroxyethyl cellulose, and hydroxypropyl trimethyl ammonium chloride hydroxyethyl cellulose); alginates and water-soluble gums; dextrans; carrageenan; xanthan; chitosan; proteins; gelatins; agar; and mixtures thereof.

In addition, the porous ink-receptive layer 16 may contain additives such as pigments for coloration, surface active agents to influence the wetting or spreading action of the coating as it is applied to the substrate, anti-static agents, suspending agents, compounds to control the pH of the coating, optical brighteners, de-foamers, humectants, waxes, plasticizers, and the like.

The above-described conventional coating methods, for example, Meyer-rod coating methods, which may used to apply the intercoat layer, also may be used to apply the porous ink-receptive layer 16 in accordance with this invention.

Coating of Back Surface of Substrate

In addition, the back surface of the base substrate 12 may be coated with a polymeric layer 18 beneath the PSA coating. This polymeric layer 18 further helps prevent moisture from penetrating into the base substrate 12. The polymeric coating 18 on the back surface of the substrate 12 enhances the substrate's 12 dimensional stability and helps minimize substrate curling, cockling, and other defects. The back coating 18 also provides surface-friction to assist feeding of the imaging medium 10 into an ink-jet printer. The back coating 18 typically also provides anti-static properties to the ink-jet imaging medium 10.

Advantageous Properties of the Ink-Jet Recording Medium

The resulting ink-jet imaging medium produced in accordance with this invention offers several improvements over conventional ink-jet media. First, the use of a stable and absorptive intercoat makes it feasible to produce a high quality medium with a microporous topcoat (ink-receiving layer) using drying conditions that provide a significant economic advantage. This advantage arises because the relatively high temperature and high air flow conditions of a short, high speed oven can be used, and this is less expensive than using a slow drying processes in long expensive ovens using less forcing conditions to achieve the same drying. Second, the stability of the intercoat of this invention reduces the mechanical requirements on the topcoat and this permits the use of higher pigment to binder mass ratio than would be needed otherwise. That, in turn, makes it possible to achieve the needed ink vehicle absorptivity with lower coat weight than would be required otherwise. Third, the absorbance capacity of the intercoat further reduces the absorbance capacity requirement of the topcoat. The manufacturing process used to make the ink-jet media 10 of this invention is robust and cost-effective.

Other advantages of the intercoat layer 14 includes the controlled swelling and wet strength of this layer 14. The wet strength of the intercoat layer means 14 that the highly pigmented microporous layer 16 can be coated effectively over this intercoat layer 14. This combination of coatings provides a final coated medium 10 having a strong and durable coating that is less likely to crack under stresses.

Also, the media 10 of this invention have improved ink-drying times over conventional media. The ink-jet imaging medium 10 has good water-resistance so that the printed image is less likely to smear or rub-off after the image is wetted. The ink-jet medium 10 can produce high quality printed images having high color brilliance, sharpness, and fidelity.

### EXAMPLES

Some examples of the ink-jet imaging media 10 of this invention are illustrated below. These examples should not be construed as limiting the scope of the invention. In the following examples, percentages are by weight based on the weight of the finished dry coating, unless otherwise indicated.

Intercoat Formulations

Intercoat 14 formulations were prepared at 10%-20% solids in water to have the final dry coating material compositions listed. The coating then were applied over a clay coated paper or a polyester (PET) substrate, as designated, using a Meyer-rod. The substrate coated with the intercoat layer 14 was dried in a convection oven for 3 minutes at 100° C.

Examples of Intercoats of the Invention

### Example 1

| Trade Name | Supplier | Description | % Weight (solids) |
|---|---|---|---|
| Joncryl 624 | Johnson | Styrene Acrylic | 69.9 |
| | Polymers | Copolymer | |
| PVP-K60 | ISP | poly(vinyl pyrrolidone) | 30 |
| BYK 380 | Byk-Chemie | Fluorinated acrylic | 0.1 |

### Example—2

| | | | % Weight |
|---|---|---|---|
| Trade Name | Supplier | Description | (solids) |
| Joncryl HPD-71 | Johnson | Styrene Acrylic Solution | 30 |
| | Polymers | Copolymer | |
| | | (high Tg, high acid#) | |
| Joncryl 624 | Johnson | Styrene Acrylic Emulsion | 39.9 |
| | Polymers | Copolymer | |
| | | (low Tg, low acid#) | |
| BYK 380 | Byk-Chemie | Fluorinated acrylic | 0.1 |
| PVP-K60 | ISP | Polyvinyl Pyrrolidone | 30 |

### Example—3

| | | | % Weight |
|---|---|---|---|
| Trade Name | Supplier | Description | (solids) |
| Joncryl | Johnson | Styrene Acrylic Solution | 29 |
| HPD-71 | Polymers | Copolymer | |
| | | (high Tg, high acid#) | |
| Joncryl 624 | Johnson | Styrene Acrylic Emulsion | 38.9 |
| | Polymers | Copolymer | |
| | | (low Tg, low acid#) | |
| BYK 380 | Byk-Chemie | Fluorinated acrylic | 0.1 |
| PVP-K60 | ISP | poly(vinyl pyrrolidone), PVP | 29 |
| Borax | Spectrum | sodium tetraborate decahydrate | 3.0 |
| | Chemicals | | |

### Example 4

| | | | % Weight |
|---|---|---|---|
| Trade Name | Supplier | Description | (solids) |
| Joncryl | Johnson | Styrene Acrylic Solution | 30 |
| HPD-71 | Polymers | Copolymer | |
| | | (high Tg, high acid#) | |
| Joncryl 624 | Johnson | Styrene Acrylic Emulsion | 39.9 |
| | Polymers | Copolymer | |
| | | (low Tg, low acid#) | |
| BYK 380 | Byk-Chemie | Fluorinated acrylic | 0.1 |
| Mowiol 47-88 | Kuraray | poly (vinyl alcohol), PVA | 30 |

### Example 5

| | | | % Weight |
|---|---|---|---|
| Trade Name | Supplier | Description | (solids) |
| Joncryl | Johnson | Styrene Acrylic Solution | 29 |
| HPD-71 | Polymers | Copolymer | |
| | | (high Tg, high acid#) | |
| Joncryl 624 | Johnson | Styrene Acrylic Emulsion | 38.9 |
| | Polymers | Copolymer | |
| | | (low Tg, low acid#) | |
| BYK 380 | Byk-Chemie | Fluorinated acrylic | 0.1 |
| methocel E-15 | Dow | methocel E-15 | 29 |
| Borax | Spectrum | sodium tetraborate | 3.0 |
| | Chemicals | decahydrate | |

### Example 6

| | | | % Weight |
|---|---|---|---|
| Trade Name | Supplier | Description | (solids) |
| Joncryl | Johnson | Styrene Acrylic Solution | 32.8 |
| HPD-71 | Polymers | Copolymer | |
| | | (high Tg, high acid#) | |
| Joncryl 624 | Johnson | Styrene Acrylic Emulsion | 49.1 |
| | Polymers | Copolymer | |
| | | (low Tg, low acid#) | |
| BYK 380 | Byk-Chemie | Fluorinated acrylic | 0.1 |
| methocel E-15 | Dow | methocel E-15 | 15 |
| Borax | Spectrum | sodium tetraborate | 3.0 |
| | Chemicals | decahydrate | |

Topcoat Formulations

The following topcoat 16 formulations were prepared and applied over the above-described intercoated samples using a Meyer-rod. The compositions listed are in terms of the dry weight percentages in the finished coating. The coating fluids also contain water, typically at 25%-30% solids, which is taken off in the drying process. In Examples 7 and 8, the alumina is first dispersed in acidic aqueous solution to achieve a dispersion pH of approximately 3.0-4.0. Then the other components are added to make the final topcoat fluids.

### Example 7

| Trade Name | Supplier | Description | % Weight |
|---|---|---|---|
| Poval 235 | Kuraray | Polyvinyl alcohol | 10.3 |
| Dispal 14N4-80 | Sasol | Aluminum hydroxide | 89 |
| | | dispersion | |
| BYK 380 | Byk-Chemie | Fluorinated acrylic | 0.1 |
| Acetic Acid | Aldrich | Organic acid | 0.1 |
| Chemcor 540C25 | Chemcor | PE emulsion | 0.1 |

### Example 8

| Trade Name | Supplier | Description | % Weight |
|---|---|---|---|
| Poval 245 | Kuraray | Polyvinyl alcohol | 6.2 |
| Dispal 14N4-80 | Sasol | Aluminum hydroxide | 93.6 |
| | | dispersion | |
| BYK 380 | Byk-Chemie | Fluorinated acrylic | 0.1 |
| Chemcor 540C25 | Chemcor | PE emulsion | 0.1 |
| Acetic Acid | Aldrich | Organic acid | .1 |

Comparative Example of Intercoat Formulations

### Comparative Example 1

In this example, the intercoat consisted of Mowinol 47-88 poly(vinyl alcohol), PVA. It was prepared as an 8% solids aqueous solution.

### Comparative Example 2

In this comparative example, the following intercoat formulation was prepared.

| Chemical | Supplier | Wt % | Description |
|---|---|---|---|
| Poval 245 | Kuraray | 95 | Polyvinyl alcohol |
| Glyoxal | J. T. Baker | 5 | Ethanediol |

### Comparative Example 3

| Chemical | Supplier | Wt % | Description |
|---|---|---|---|
| methocel | Dow | 96.9 | methocel |
| E-15 | | | |
| Borax | Spectrum Chemicals | 3.0 | sodium tetraborate decahydrate |
| BYK 380 | Byk-Chemie | 0.1 | Fluorinated acrylic |

Examples of Coated Media

In each of the following examples (Examples 9-34), a substrate was selected. It was either topcoated over a substrate with no intercoat, or it was topcoated over a specified dried intercoat. The intercoat layer 14 was dried in a convection oven for 3 minutes at 100° C. Each sample thus had a specified topcoat applied and this was dried fewer than one of the following two conditions:

Topcoat Dry Condition 1: Drying in a convection oven for 3 minutes at 100° C. This condition is used to model slow drying conditions.

Topcoat Dry Condition 2: Drying with a Masterflow Model AH-501 heat blower at 125-130° C. for about 1-2 minutes. This condition is used to model drying in a high capacity drying oven with high heat and air flow.

### Example 9

A piece of Garda 80 lb. clay coated paper was coated at 25 gsm (grams per square meter) with the coating of Example 7 and dried using drying condition 1. Observations of the sample texture were made visually and are presented in Table 1.

### Example 10

A piece of Garda 80 lb. clay coated paper was coated at 25 gsm (grams per square meter) with the coating of Example 7 and dried using drying condition 2. Observations of the sample texture were made visually and are presented in Table 1.

### Example 11

A piece of Garda 80 lb. clay coated paper was coated at 25 gsm (grams per square meter) with the coating of Example 8 and dried using drying condition 1. Observations of the sample texture were made visually and are presented in Table 1.

### Example 12

A piece of Garda 80 lb. clay coated paper was coated at 25 gsm (grams per square meter) with the coating of Example 8 and dried using drying condition 2. Observations of the sample texture were made visually and are presented in Table 1.

### Example 13

A piece of Garda 80 lb. clay coated paper was coated at 8 gsm with the coating of Comparative Example 2 and dried. Then it was coated at 25 gsm with the coating of Example 7 and dried using Drying Condition 1. Observations of the surface texture were made visually and are given in Table 1.

### Example 14

A piece of Garda 80 lb. clay coated paper was coated at 8 gsm with the coating of Comparative Example 2 and dried. Then it was coated at 25 gsm with the coating of Example 7 and dried using Drying Condition 2. Observations of the surface texture were made visually and are given in Table 1.

### Example 15

A piece of Garda 80 lb. clay coated paper was coated at 8 gsm with the coating of Example 1 and dried. Then it was coated at 25 gsm with the coating of Example 7 and dried using Drying Condition 1. Observations of the surface texture were made visually and are given in Table 1.

### Example 16

A piece of Garda 80 lb. clay coated paper was coated at 8 gsm with the coating of Example 1 and dried. Then it was coated at 25 gsm with the coating of Example 7 and dried using Drying Condition 2. Observations of the surface texture were made visually and are given in Table 1.

### Example 17

A piece of Garda 80 lb. clay coated paper was coated at 8 gsm with the coating of Example 2 and dried. Then it was coated at 25 gsm with the coating of Example 7 and dried using Drying Condition 1. Observations of the surface texture were made visually and are given in Table 1.

### Example 18

A piece of Garda 80 lb. clay coated paper was coated at 8 gsm with the coating of Example 2 and dried. Then it was coated at 25 gsm with the coating of Example 7 and dried using Drying Condition 2. Observations of the surface texture were made visually and are given in Table 1.

### Example 19

A piece of Garda 80 lb. clay coated paper was coated at 8 gsm with the coating of Example 3 and dried. Then it was coated at 25 gsm with the coating of Example 7 and dried using Drying Condition 1. Observations of the surface texture were made visually and are given in Table 1.

### Example 20

A piece of Garda 80 lb. clay coated paper was coated at 8 gsm with the coating of Example 3 and dried. Then it was coated at 25 gsm with the coating of Example 7 and dried using Drying Condition 2. Observations of the surface texture were made visually and are given in Table 1.

### Example 21

A piece of Garda 80 lb. clay coated paper was coated at 8 gsm with the coating of Example 3 and dried. Then it was coated at 25 gsm with the coating of Example 8 and dried using Drying Condition 1. Observations of the surface texture were made visually and are given in Table 1.

### Example 22

A piece of Garda 80 lb. clay coated paper was coated at 8 gsm with the coating of Example 3 and dried. Then it was coated at 25 gsm with the coating of Example 8 and dried using Drying Condition 2. Observations of the surface texture were made visually and are given in Table 1.

### Example 23

A piece of 3.8 mil DuPont 565 PET (polyester terephthalate) was coated at 25 gsm (grams per square meter) with the coating of Example 8 and dried using drying condition 1. Observations of the sample texture were made visually and are presented in Table 1.

### Example 24

A piece of 3.8 mil DuPont 565 PET (polyester terephthalate) film was coated at 25 gsm (grams per square meter) with the coating of Example 8 and dried using drying condition 2. Observations of the sample texture were made visually and are presented in Table 1.

### Example 25

A piece of 3.8 mil DuPont 565 PET film was coated with the coating of Comparative Example 1 at 2 gsm and dried. Then it was coated at 25 gsm with the coating of Example 8 and dried using Drying Condition 1. Observations of the surface texture were made visually and are given in Table 1.

### Example 26

A piece of 3.8 mil DuPont 565 PET film was coated with the coating of Comparative Example 1 at 8 gsm and dried. Then it was coated at 25 gsm with the coating of Example 8 and dried using Drying Condition 1. Observations of the surface texture were made visually and are given in Table 1.

### Example 27

A piece of 3.8 mil DuPont 565 PET film was coated with the coating of Example 4 at 8 gsm and dried. Then it was coated at 25 gsm with the coating of Example 7 and dried using Drying Condition 1. Observations of the surface texture were made visually and are given in Table 1.

### Example 28

A piece of 3.8 mil DuPont 565 PET film was coated with the coating of Example 4 at 8 gsm and dried. Then it was coated at 25 gsm with the coating of Example 7 and dried using Drying Condition 2. Observations of the surface texture were made visually and are given in Table 1.

### Example 29

A piece of 3.8 mil DuPont 565 PET film was coated with the coating of Example 2 at 8 gsm and dried. Then it was coated at 25 gsm with the coating of Example 8 and dried using Drying Condition 1. Observations of the surface texture were made visually and are given in Table 1.

### Example 30

A piece of 3.8 mil DuPont 565 PET film was coated with the coating of Example 6 at 8 gsm and dried. Then it was coated at 25 gsm with the coating of Example 8 and dried using Drying Condition 1. Observations of the surface texture were made visually and are given in Table 1.

### Example 31

A piece of 3.8 mil DuPont 565 PET film was coated with the coating of Example 3 at 8 gsm and dried. Then it was coated at 25 gsm with the coating of Example 8 and dried using Drying Condition 1. Observations of the surface texture were made visually and are given in Table 1.

### Example 32

A piece of 3.8 mil DuPont 565 PET film was coated with the coating of Example 3 at 8 gsm and dried. Then it was coated at 25 gsm with the coating of Example 8 and dried using Drying Condition 2. Observations of the surface texture were made visually and are given in Table 1.

### Example 33

A piece of 3.8 mil DuPont 565 PET film was coated with the coating of Example 6 at 8 gsm and dried. Then it was coated at 25 gsm with the coating of Example 8 and dried using Drying Condition 2. Observations of the surface texture were made visually and are given in Table 1.

### Example 34

A piece of 3.8 mil DuPont 565 PET film was coated with the coating of Example 5 at 8 gsm and dried. Then it was coated at 25 gsm with the coating of Example 8 and dried using Drying Condition 2. Observations of the surface texture were made visually and are given in Table 1.

### Example 35

A piece of 3.8 mil DuPont 565 PET film was coated with the coating of Comparative Example 3 at 8 gsm and dried. Then it was coated at 25 gsm with the coating of Example 8 and dried using Drying Condition 2. Observations of the surface texture were made visually and are given in Table 1.

TABLE 1
Observations of the quality of the coated media prepared in Examples 9-35

| | Coating | |
|---|---|---|
| Media Example | Quality Rating: Splits | Coating Quality Rating: Cracks |
| 9 | 5 | 4 |
| 10 | 2 | 1 |
| 11 | 3 | 3 |
| 12 | 1 | 0 |
| 13 | 3 | 4 |
| 14 | 2 | 2 |
| 15 | 5 | 4 |
| 16 | 5 | 3 |
| 17 | 5 | 5 |
| 18 | 5 | 4 |
| 19 | 5 | 5 |
| 20 | 5 | 5 |
| 21 | 5 | 5 |
| 22 | 5 | 5 |
| 23 | 5 | 0 |
| 24 | 3 | 3 |
| 25 | 0 | 1 |
| 26 | 0 | 1 |
| 27 | 5 | 5 |
| 28 | 5 | 5 |
| 29 | 5 | 3 |
| 30 | 5 | 5 |
| 31 | 5 | 5 |
| 32 | 5 | 5 |
| 33 | 5 | 4 |
| 34 | 5 | 5 |
| 35 | 1 | 1 |

Ratings used in Table 1: The media were evaluated on a relative scale of 0 to 5, where a rating of 5 means the medium has the excellent properties with respect to observable splits or cracks. A rating of 3 or less for cracks is unacceptable. A rating of 4 or less for coating quality for splits is unacceptable.

Media of Examples 18, 20, 22, 28, 32, 33 and 34 are excellent examples of this invention in that they have a rating of 5 for splits, 4 or 5 for cracks, and the topcoat was dried under Drying Condition 2, which provides a process and consequent economic advantage in producing good ink jet media in terms of these properties. These media also yielded excellent images when imaged using an Epson 820 Stylus Photo Printer. The intercoats are supporting intercoats that served to provide stable and absorptive support to the topcoat as it dried under forcing drying conditions.

Moreover, the media produced according to these examples performed well as aqueous-based ink jet media even with microporous topcoats that are thinner than many in the prior art (25 gsm vs. 40 or higher gsm). It is possible to conjecture, without being bound to the theory, that this is due, in part, to the high particle to binder mass ratio that is achievable in the topcoats when the topcoats are placed over the intercoats of this invention and, in part, to the additional absorptive capacity of the mechanically stable supporting intercoat.

By comparison, these topcoats coated over an absorptive but more highly swellable intercoat, such as Comparative Examples 1 and 2, used in media Examples 13, 14, 25 and 26 do not yield acceptable media. Note that these include PVA at 2 gsm and at 8 gsm and crosslinked PVA as intercoats.

Media of Examples 18, 20, 22, 28, 33 and 34 show that the absorptive component of the intercoat of this invention can be PVP, PVA or methocel, at least.

Media of Example 35 may be compared to those of Examples 33 and 34. The comparison shows that the presence of high and low Tg constituents are important to the functioning of one aspect of this invention.

Comparisons of Examples 18 and 29 with 20 and 32, respectively, show the role of borax (borates) when the binder of the microporous topcoat comprises a polymer, such as PVA, that can be gelled or crosslinked by borax.

### Example 36

A label for placement on a laptop computer was prepared using a substrate comprising a calendared vinyl film with a PSA and release liner available as FLEXmark® V 400. The second surface of the substrate was then was coated with a primer on the second surface. An intercoat was coated on the primer layer and a topcoat layer was coated on the intercoat layer. The primer coating was a mixture of methanol, aliphatic polyester polyurethane polymer and hyydroxypropyl methylcellulose. The intercoat was formulated as in Example 2 and the topcoat was formulated as in Example 8. The coatings were form edas in example 9 to 34 on a FLEXmark V 400® as the substrate (release liner, PSA and vinyl film).

The label 30 was die-cut to provide a rectangular label suitable for use on a laptop computer as shown in FIG. 2. The sheet containing label 30 was then placed in an inkjet printer and an image printed on the topcoat layer. The label shape is shown in FIG. 2 defined by edges 30, 32, 34 and 36 and having rounded corners 40. The label was peeled from the liner and placed on a laptop computer (not shown). The computer was used for several hours and the label remained securely affixed to the top of the laptop computer. The label was then peeled from the laptop computer to demonstrate the removable nature of the PSA after use on an electronic device. The final label was formed of the following layers: liner, PSA, vinyl film layer, primer layer, intercoat layer, topcoat layer and inkjet image and would be suitable for a wide range of electronic devices, such as cell phones, laptop computers and PDAs. When used for several weeks as the label for the top of a laptop computer on the back of the LCD screen, the label demonstrated high image retention and low image smearing.

It would be appreciated by those skilled in the art that various changes and modifications can be made to the illustrated embodiments without departing from the spirit of the present invention. All such modifications and changes are intended to be covered by the present invention and appended claims.

What is claimed is:

1. An electronic device decorative surface label comprising: a) a substrate having a first surface and a second surface, b) an adhesive layer on said first surface for affixing said label to the outside surface of an electronic device; and c) on said second surface an inkjet printable medium having a supporting intermediate coating overlying the imaging surface of the substrate; and a microporous ink-receptive coating overlying the supporting intermediate coating.

2. A label according to claim 1 comprising: a substrate having an imaging surface and a back surface; at least one supporting intermediate coating overlying the imaging surface of the substrate; and at least one microporous ink-receptive coating overlying the at least one supporting intermediate coating, wherein the supporting intermediate coating comprises at least one polymer with a glass transition temperature below 25 degree C., at least one polymer with a glass transition above 40 degree C., and at least one absorbent material.

3. The label of claim 2 wherein the supporting intermediate coating comprises: about 20% to about 60% by dry weight of a polymer or copolymer having a glass transition temperature of less than 25 degree C.; about 10% to about 40% by dry weight of a polymer or copolymer having a glass transition of greater than 35 degree C.; and about 5% to about 40% of an absorbent material.

4. The label of claim 3 wherein the supporting intermediate coating comprises: about 20% to about 60% by dry weight of an acrylic polymer or copolymer having a glass transition temperature of less than 25 degree C.; about 10% to about 40% by dry weight of an acrylic polymer or copolymer having a glass transition of greater than 35 degree C.; and about 5% to about 40% of an absorbent material selected from the group comprising PVP, PVA, PEOX, and alkylcelluloses.

5. The label of claim 1, further comprising a release liner, said liner preventing the adhesive layer from engaging surfaces when the protective cover is not in use.

6. The label of claim 1 wherein said electronic device is selected from the group consisting of cellular phones, personal display assistants, palm pilots, computers, laptop computers, MP3 players, music devices, video devices, portable music devices, portable video devices, portable audio devices, electronic organizers, remote controls for electronic devices, display terminals and electronic gaming systems.

7. The label of claim 1, wherein said adhesive layer comprises a pressure sensitive adhesive.

8. The label of claim 7, wherein said pressure sensitive adhesive comprises a vinyl pressure sensitive adhesive, a silicone pressure sensitive adhesive, an acrylic pressure sensitive adhesive or a rubber pressure sensitive adhesive or a combination thereof.

9. The label of claim 7, wherein said pressure sensitive adhesive is removable.

10. The label of claim 7, wherein said pressure sensitive adhesive is non-removable.

11. The label of claim 1, said cover being contoured to the shape of one or more external surfaces of an electronic device.

12. The label of claim 11, further comprising one or more apertures, tear away sections, punch out sections, perforated sections, die-cut sections, peel away sections or a combination thereof from the liner.

13. The label of claim 1, said label characterized as being flexible and tear resistant.

14. The label of claim 1, said cover comprising a thickness of about 3 mil and about 20 mil.

15. The label of claim 14, said cover comprising a thickness in the range of about 3 mil to about 15 mil.

16. The label of claim 1, further comprising one or more film laminates is applied to the layer comprising the microporous layer after an image has been printed on the microporous layer.

17. The label of claim 16, said label is customized to comprise text, graphics, photographs, advertisements, bar codes or a combination thereof.

18. The label of claim 17 wherein the label has a bar code.

19. The label according to claim 1 wherein the substrate is selected from the group consisting of cast vinyl, calendared vinyl, plastic, paper, acrylic, RFID label, GPS label, color change plastic, odor/fragrance release plastic and combinations thereof.

20. The label of claim 19, further comprising a polymeric curl-controlling coating overlying the back surface of the substrate between the substrate and adhesive.

21. The label of claim 1, wherein the supporting intermediate coating comprises an acrylic copolymer having an acid functionality of at least 25.

22. The label of claim 1, wherein the supporting intermediate coating comprises from about 60% to about 90% by dry weight of an acrylic copolymer.

23. The medium of claim 6, wherein the supporting intermediate coating further comprises from about 10% to about 40% by dry weight of poly(vinyl pyrrolidone).

24. The medium of claim 6, wherein the acrylic copolymer has a glass transition temperature (Tg) less than 25.degree. C.

25. The medium of claim 6, wherein the acrylic copolymer has an acid functionality of at least 25.

26. The medium of claim 6, wherein the acrylic copolymer is a styrene acrylic.

27. The medium of claim 1, wherein the supporting intermediate coating comprises: about 20% to about 60% by dry weight of an acrylic copolymer having a glass transition temperature of less than 25 degree C.; about 10% to about 40% by dry weight of an acrylic copolymer having a glass transition temperature of greater than 25 degree C.; and about 20% of poly(vinyl pyrrolidone).

28. The medium of claim 1, wherein said supporting intermediate coating includes a cross-linking agent.

29. The medium of claim 1, wherein said microporous ink-receptive coating comprises a dispersion of particles and a polymer resin binder, and wherein said supporting intermediate coating further comprises a cross-linking agent reactive with said polymer resin binder of said microporous ink-receptive coating.

30. The medium of claim 1, wherein said cross-linking agent comprises a borate salt.

31. An ink-jet printable medium comprising: a substrate having an imaging surface and a back surface; at least one supporting intermediate coating overlying the imaging surface of the substrate; and at least one microporous ink-receptive coating overlying the at least one supporting intermediate coating, wherein the supporting intermediate coating comprises at least one polymer with a glass transition temperature below 25 degree C., at least one polymer with a glass transition above 40 degree C., and at least one absorbent material.

32. The medium of claim 15 wherein the supporting intermediate coating comprises: about 20% to about 60% by dry weight of a polymer or copolymer having a glass transition temperature of less than 25 degree C.; about 10% to about 40% by dry weight of a polymer or copolymer having a glass transition of greater than 35 degree C.; and about 5% to about 40% of an absorbent material.

33. The medium of claim 15 wherein the supporting intermediate coating comprises: about 20% to about 60% by dry weight of an acrylic polymer or copolymer having a glass transition temperature of less than 25 degree C.; about 10% to about 40% by dry weight of an acrylic polymer or copolymer having a glass transition of greater than 35 degree C.; and about 5% to about 40% of an absorbent material selected from the group comprising PVP, PVA, PEOX, and alkylcelluloses.

34. The label according to claim 1 wherein the label is for a laptop computer and has color change properties when the label is heated while the laptop computer is turned on.

35. The label according to claim 1 wherein the label is for a laptop computer and has odor release properties when the label is heated or rubbed while on the laptop.

36. The label according to claim 1 wherein the label is for a laptop computer and makes a sound when the label is heated while the laptop computer is turned on.

37. The label according to claim 1 wherein the label is for a laptop computer and comprises a RFID label as the substrate.

38. The label according to claim 1 wherein the label is for a laptop computer and comprises a GPS label as the substrate.

39. The label according to claim 1 wherein the label is for a laptop computer and comprises a GPS and an RFID label as the substrate.

40. The label according to claim 1 wherein the label is for a laptop computer and either changes color, generates an odor or makes a sound while on the laptop.

41. The label according to claim 1 wherein the label is for a laptop computer and comprises a substantially rectangular shape with rounded corners that prevent inadvertent removal.

42. The label according to claim 1 wherein the label is for a laptop computer and has high gloss and is smear resistant.

43. The label according to claim 1 wherein the label is on a laptop computer wherein: a) said label has a printed image and contains a sound generating electronic circuit and a WiFi electronic circuit; b) and said sound generating electronic circuit can be activated to make a sound through said WiFi electronic circuit thru a signal sent through the Internet.

44. The label according to claim 43 wherein the sound is related to an image printer on the label.
